(19) United States
(12) Patent Application Publication
(10) Pub. No.: US 2004/0207224 A1
(43) Pub. Date: Oct. 21, 2004

(54) Folding step and decorative hitch cover

(76) Inventors: Charles W. Miller, Fallbrook, CA (US); David R. Williams, Rainbow, CA (US)

Correspondence Address: ROY A. EKSTRAND, 3158 REDHILL AVE., STE 150, COSTA MESA, CA, 92626, US

(21) Appl. No.: 10/418,390

(22) Filed: Apr. 17, 2003

(51) Int. Cl. B62D 33/03

(52) U.S. Cl. 296/21; 296/57.1

(57) ABSTRACT

A generally square cross section support is configured to be received within the receptacle of a conventional trailer hitch of a vehicle. A step plate having a generally planar shape is pivotally secured to the outer end of the support and is pivotable between a raised or vertical orientation and a lowered or horizontal step providing orientation. An over-center spring mechanism is operative upon the step plate to provide stable step plate positioning in either of its two positions. In an alternate embodiment, a source of illumination which is operative in the lowered step providing position of the step plate is utilized.

### FIELD OF THE INVENTION

This invention relates generally to apparatus known as trailer hitches and/or towing hitches and particularly to apparatus utilized in connection therewith which provides the additional function of a convenient step for the user.

### BACKGROUND OF THE INVENTION

For many years various types of vehicles have been equipped with so-called “trailer hitches” or “towing hitches” generally referred to herein as hitches. Basically, such hitches are secured to the rear portion of the host vehicle and are positioned so as to terminate in a rearwardly extending element. At their rear most portions, a coupler such as a hitch ball is secured. The coupler operates to engage a cooperating element such as a socket, on the trailer to couple the hitch and trailer to the host vehicle.

One of the more popular types of hitches developed in recent years, utilizes a spherical ball element supported upon a short section of square cross sectioned tubing. A corresponding but slightly larger square cross section hitch support is secured to the host vehicle and extends rearwardly defining an open end. The ball supporting smaller square cross section support is slideable within the rearwardly extending portion of the hitch and is secured therein. The ball and its support as a result removably attachable to the square cross section receptacle formed in the rear portion of the trailer hitch. The attachment is completed by one or more securing pins passing through both square cross sectioned elements or other similar apparatus.

The primary benefit in providing a two piece hitch structure with a removable ball and ball support is found in the ability to avoid continuously having an extending ball element on the host vehicle during periods of nonuse.

With the extensive rise in popularity of vehicles such as sport utility vehicles (SUV's) and pickup trucks among a broad base of consumers, the popularity of hitches has also correspondingly increased. Because of the broader use of such hitches, the aesthetic and convenience aspects found in a two piece removable type of hitch has become the most commonly used and is the hitch of preference for most noncommercial users.

In most applications, the hitch is secured to the rear portion of the host vehicle such that the rearwardly extending portion of the hitch forming the receptacle for the ball support extends beneath the rear bumper and terminates in approximate alignment with the rear most surface of the vehicle bumper. Correspondingly, the extension required for proper hitch attachment to a trailer or the like, is provided by the ball support as it extends from the receptacle in the attached configuration. The result is a convenient trailer or towing hitch which does not degrade the convenience or appearance of the host vehicle when the hitch is not in use and the ball and its support are removed from the hitch.

Not surprisingly, practitioners in the art have endeavored to further enhance the appearance of the hitch receptacle beneath the vehicle bumper beyond its basic configuration. As a result, practitioners have provided a variety of decorative elements which are supported by a cooperating square cross sectioned tube sized and configured to be secured within the hitch receptacle in the same general manner as the ball support itself. For example, U.S. Pat. No. 6,463,686B1 sets forth a COVER FOR HITCH RECEIVER having a generally U-Shaped square support member sized to fit within the hitch receptacle which in turn further supports a decorative plate element covering the hitch receptacle.

U.S. Pat. No. 4,040,641 sets forth a square cross sectioned element which is fitted within the hitch receptacle and which further supports a square cover plate.

U.S. Pat. No. 6,019,386 issued to Morelock sets forth a PROTECTIVE COVER FOR A TRAILER HITCH having a frame element which is secured to the hitch receptacle and a hinged cover supported thereby. The hinge cover is rotatable between a closed position covering the hitch receptacle and an open position exposing it for receiving a ball support.

U.S. Pat. No. 5,063,178 issued to Morrison sets forth an ORNAMENTAL COVER FOR TRAILER HITCH SOCKET which includes a cover plate secured to a rearwardly extending arm. The arm fits within the hitch receptacle and defines an aperture which receives a threaded bolt through the hitch receptacle pin aperture to secure the cover.

U.S. Pat. No. 5,934,699 issued to Blake sets forth a TRAILER HITCH COVER ASSEMBLY having a hitch insert for connection to the hitch receptacle and a top cover plate mounted to the hitch insert. A front cover plate mounted to the hitch insert defines an aperture extending therethrough aligned with the trailer hitch.

U.S. Pat. No. 6,418,650B1 issued to Krewald sets forth a MESSAGE INSERT FOR A TRAILER HITCH RECEIVER which is securable to the hitch receptacle and which supports a plurality of Alfa numeric characters combined to form a message.

U.S. Pat. No. 5,421,601 issued to Hinze et al. sets forth a TRAILER HITCH COVER which includes a removable hollow housing and latch for securing the hollow housing to the hitch such that it will remain in place. The hollow housing includes an elongated body and a tubular neck protruding there from.

U.S. Pat. No. 5,560,631 issued to Salvo sets forth a TRAILER HITCH COVER having a multiply faceted hitch cover plate formed to overly and generally cover the structural elements of the hitch receptacle and its supporting structural members. The function of the hitch cover is to improve the appearance of the hitch upon the host vehicle.

U.S. Pat. No. 6,481,743B1 issued to Blake sets forth a TRAILER HITCH COVER ASSEMBLY which includes a clamp assembly having an aperture extending longitudinally therethrough to fit over a hitch tube of a trailer hitch. The clamp assembly also includes an inner clamp disposed over the hitch tube which supports an outer clamp disposed over the inner clamp.

A substantial number of design patents have been issued which are directed to different appearance trailer hitch covers and which all generally utilize a supporting element received within the hitch cover. These structures differ primarily in the appearance of the cover plate element and include for example Des.426,798; D462,303; Des.415,080; Des.425,460; Des.344,257; D435,812; Des.433,358 and D444,433.

Still other variation of trailer hitch covers are found in U.S. Pat. No. D458,195 issued to Beauvais which sets forth a TRAILER HITCH COVER having a source of illumination and an illuminated image plate therein. The hitch cover is received and secured within the hitch receptacle and coupled to a source of electrical power. The illumination means produces an image on a rearwardly facing image plate cover.

U.S. Pat. No. 6,357,899B1 issued to Craven sets forth a TRAILER HITCH ATTACHMENT WITH ILLUMINATED LOGO having a support element received within the hitch receptacle which supports an illumination source and apparatus for coupling the source to electrical power. An illumination plate having a logo thereon is positioned overlying the illumination source and covering the hitch receptacle.

In addition to the large number of aesthetic improvements provided by practitioners in the art in connection with trailer hitches or the like, practitioners have provided a further variety of apparatus useable in such trailer hitches which produces a utility such as convenient step point or the like. For example, U.S. Pat. No. 6,145,865 issued to Cannara et al. sets forth an COMBINED TRAILER HITCH COVER AND STEP ASSEMBLY in which a generally planar step member is secured to the hitch receptacle of a vehicle hitch by a pivot pin and a pair of spaced apart flanges. The flanges and pin pivotally secure the step portion to the vehicle hitch and are alternately positionable between a lowered position for use as a step and a raised position in which the step forms a cover plate for the hitch receptacle.

U.S. Pat. No. 5,738,362 issued to Ludwick sets forth a ROTATING STEP FOR A TRAILER HITCH having a generally square cross sectioned support member receivable within the hitch receptacle and secured by a transverse pin. The support further includes a downwardly extending cylindrical rod which in turn supports a horizontally disposed step member. The rod and step pivot within the support member between positions underlying the hitch portion and extending outwardly to an exposed position for use as a step.

U.S. Pat. No. D463,345 issued to Cipolla sets forth a TRAILER HITCH STEP having an elongated generally cylindrical step member defining a center faceted portion securable to a square cross-sectioned L-Shaped support element. The horizontal portion of the L-Shaped support element is received within a hitch receptacle to secure the step beneath the rear of the vehicle.

U.S. Pat. No. 5,829,774 sets forth a similar step structure having an elongated round tube secured to a square cross-sectioned support element. The square cross-sectioned support element is received within and secured to a hitch receptacle to secure the step element beneath the vehicle bumper.

Despite the continuing and long standing series of improvements provided by practitioners in the art for trailer hitch covers and the like, there remains nonetheless a continuing need in the art for evermore improved, interesting, aesthetically appealing and convenient apparatus for use in cooperation with a vehicle hitch.

### SUMMARY OF THE INVENTION

Accordingly, it is a general object of the present invention to provide an improved accessory for use in combination with a vehicle hitch. It is a more particular object of the present invention to provide a convenient apparatus which provides a folding step and decorative hitch cover for a vehicle hitch. It is a still more particular object of the present invention to provide a convenient folding step and decorative hitch cover which is easily moved between positions of use and positions of hitch cover.

In accordance with the present invention there is provided for use in combination with a vehicle trailer hitch in which the trailer hitch includes a hitch receptacle, a folding step and decorative hitch cover comprising: a support having a first end configured to be secured to a hitch receptacle and a second end; a step plate pivotally secured to the second end, movable between a closed position and a lowered position; and an over-center spring mechanism operative upon, the step plate to bias the step plate toward the closed position and the open position away from positions therebetween.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a top view of a folding step and decorative hitch cover constructed in accordance with the present invention which is configured in its raised or covering position;

FIG. 2 sets forth a top view of the present invention folding step and decorative hitch cover in the lowered or step position;

FIG. 3 sets forth a section view of the present invention folding step and decorative hitch cover taken along section lines 3-3 in FIG. 1;

FIG. 4 sets forth a section view of the present invention folding step and decorative hitch cover taken along section lines 4-4 in FIG. 2;

FIG. 5 sets forth a partial section view of an alternate embodiment of the present invention folding step and decorative hitch cover;

FIG. 6 sets forth a top view of a still further alternate embodiment of the present invention folding step and decorative hitch cover;

FIG. 7 sets forth a side elevation view of a still further alternate embodiment of the folding step and decorative hitch cover of the present invention;

FIG. 8 sets forth a section view of a still further alternate embodiment of the present invention folding step and decorative hitch cover;

FIG. 9 sets forth a perspective view of a portion of a typical sport utility vehicle or truck having an alternate use of present invention folding step and decorative hitch cover.

### DESCRIPTION OF THE PREFERRED EMBODIMENTS

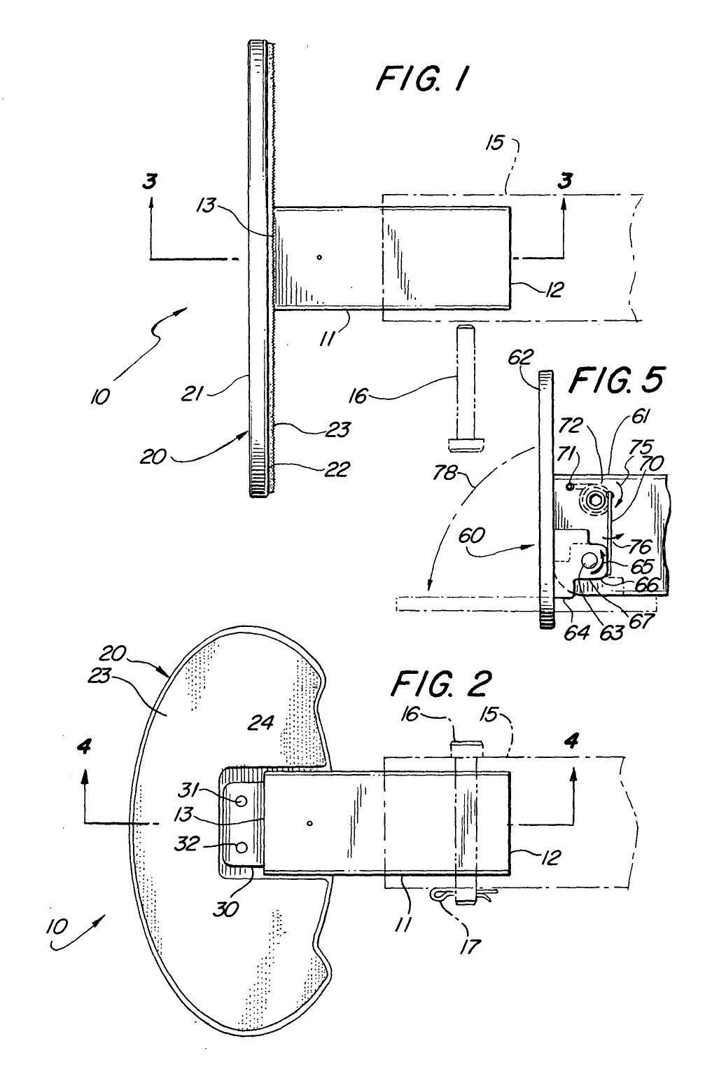

FIG. 1 sets forth a top view of a folding step and decorative hitch cover constructed in accordance with the present invention and generally referenced by numeral 10. Folding step 10 is shown in FIG. 1 in its closed or decorative position in which a hitch cover is provided. More specifically, folding step 10 includes an elongated square cross sectioned support 11 having an end 12 and an end 13. In its anticipated use, folding step 10 is secured within a hitch receptacle 15 shown in phantom line depiction which, will be understood to be constructed in accordance with conventional fabrication techniques. Also in accordance with convention fabrication techniques, hitch receptacle 15 includes a securing pin 16 which, as is better seen in FIG. 2, passes through support 11 and hitch receptacle 15 to provide attachment therebetween and which is secured by a spring clip 17.

Returning to FIG. 1, folding step 10 further includes a generally planar step plate 20 defining an external cover surface 21 and an internal step surface 22. A high friction pad 23 is shaped in general conformity to step plate 20 and is secured thereto by conventional attachment such as adhesive attachment or the like (not shown). Pad 23 is intended to provide some cushioning effect but more importantly is intended to provide a higher friction or a better foot grip for the user when the present invention folding step is utilized in accordance in the manner described below.

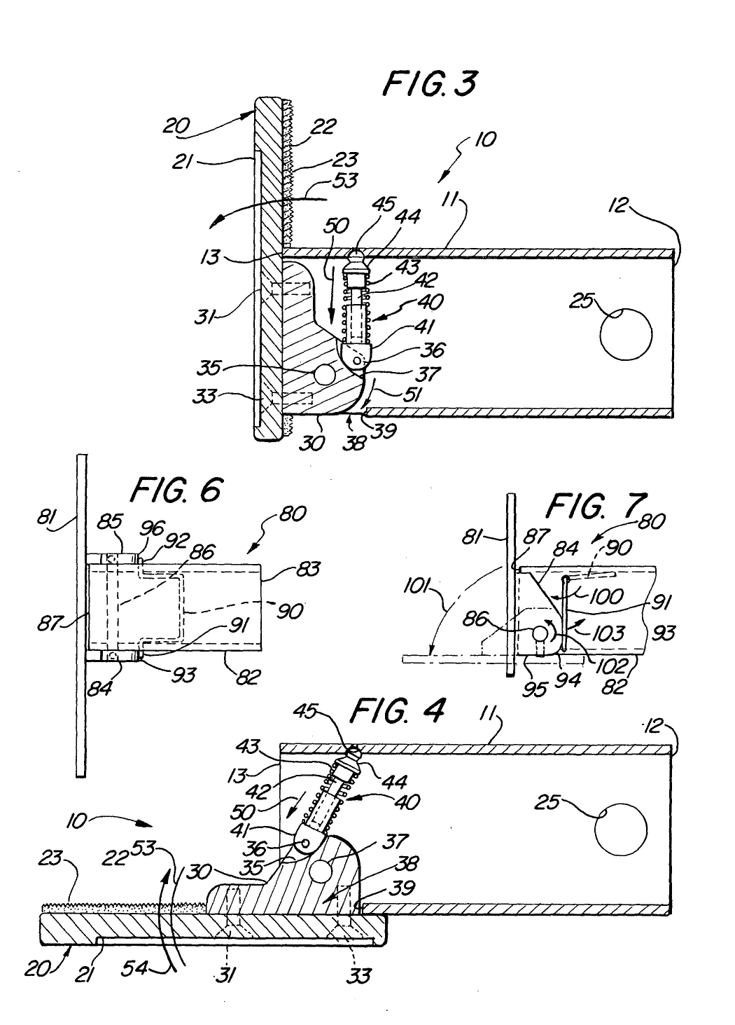

In the raised position shown in FIG. 1, the operative spring and hinge apparatus set forth below in FIGS. 3 and 4 in greater detail is operative to raise step plate 20 to a generally vertical orientation in which it presents a covering for hitch receptacle 15. Accordingly, it will be understood that cover surface 21 may further support a suitable decoration or indicia as desired for viewing by persons behind the host vehicle (not shown).

FIG. 2 sets forth the top view of FIG. 1 with folding step 10 moved to its open or step providing configuration. As described above, the host vehicle (not shown) includes a conventional hitch support 15 having an attachment pin 16 and a securing clip 17 all fabricated in accordance with conventional fabrication techniques. It will be understood by those skilled in the art that the present invention folding step may be suitably configured hitch receptacle for other different types of hitches. The important aspect with respect to the present invention is the ability of support 11 of folding step 10 to be configured such that it may be secured within the vehicle hitch receptacle such as receptacle 15.

More specifically, folding step 10 includes a support 11 defining a generally square cross section and having an end 12 received within hitch receptacle 15 and an outer end 13. A hinge plate 30, the structure of which is set forth below in FIGS. 3 and 4 in greater detail, is pivotally secured to end 13 of support 11. A generally planar step plate 20 is secured to hinge plate 30 by a plurality of fasteners such as fasteners 31 and 32. Step plate 20 further supports a friction pad 23 on the interior surface thereof.

In the open configuration shown in FIG. 2, the user is able to place one or both feet upon step plate 20 to provide a more advantageous stance with respect to the host vehicle (not shown). Of importance with respect to the present invention and as is described below in greater detail, step plate 20 is stably fixed in both the upright covering position shown in FIG. 1 and the lowered step position shown in FIG. 2 due to a novel over-center spring action upon hinge plate 30.

Thus, it will be apparent by comparison of FIGS. 1 and 2 that step plate 20 may be positioned in the raised position shown in FIG. 1 and may alternatively be positioned in the lower configuration shown in FIG. 2. In each event, the position of step plate 20 is stable and securely maintained. In addition, step plate 20 may be moved between the raised configuration shown in FIG. 1 and the lowered step position shown in FIG. 2 without resort to any fasteners or latches but rather by simple movement overcoming the force of the over-center spring mechanism set forth in FIGS. 3 and 4 in greater detail. Thus the user in determining that step plate 20 is to be lowered from the position shown in FIG. 1, simply places a foot upon the upper edge of step plate 20 and forces it downwardly to the position of FIG. 2. Conversely, the user finding folding step 10 in the configuration shown in FIG. 2 is able to raise step plate 20 to the position shown in FIG. 1 by simply urging step plate 20 upwardly about hinge plate 30 and allowing the step plate to snap upwardly to its cover configuration. Because each position of step plate 20 is stable due to the novel over-center spring action shown in FIGS. 3 and 4, step plate 20 may be left in either position without concerns for rattles or vibrations or the like as the user prefers.

FIG. 3 sets forth a section view of folding step 10 taken along section lines 3-3 in FIG. 1. It is important to note that FIG. 3 shows a section view of folding step 10 having step plate 20 in its raised position.

More specifically, folding step 10 includes an elongated generally rectangular support 11 having an end 12 received within a hitch receptacle (not shown). Support 11 further defines an aperture 25 extending through the sidewall thereof. It will be understood that a corresponding aperture is aligned with an aperture 25 on the opposite side of support 11 which is not visible due to the section view of the figure. Support 11 further defines an interior end 13 and a bottom opening 38. A hinge plate 30 is positioned within the interior of support 11 and is pivotally secured to support 11 by a hinge pin 35. Hinge plate 30 is secured to a generally planar step plate 20 by a plurality of fasteners such as fasteners 31 and 33. Step plate 20 defines an outer surface 21 and a step surface 22. Step surface 22 is partially covered with a friction tab 23.

Folding step 10 further includes an extendable and collapsible rod and spring guide 40 having a rod 42 and an end 41. Rod 42 is secured to an end 44. End 44 is captivated within a concave seat 45. End 41 is pivotally secured to an interior portion of hinge plate 30 by a pivot pin 36. End 41 is generally curved about pin 36 and clears surface 37 formed in hinge plate 30.

Rod and spring guide 40 sliding over rod 42 having end 44 secured within seat 45 produces a force due to captive spring 43 downwardly upon end 41 and pin 36 in the direction indicated by arrow 50. The location of the force of rod and spring guide 40 as it attempts to expand under the urging of spring 43 and the relative positions of pin 36 and hinge pin 35 produce a pivotal force operative upon hinge plate 30 in the direction indicated by arrow 51. This force rotates step plate 20 upwardly about hinge pin 35 until surface 22 is brought into abutment with end 13 of support 11. Thereafter step plate 20 is statically positioned due to the continuing force of spring 43 operative upon pin 36 through rod and spring guide 40 and end 41. It will be noted that the spring force of rod and spring guide 40 and the position of pin 36 with respect to hinge pin 35 produces an “over-center” force upon hinge plate 30 maintaining the raised or covering position of step plate 20. Thus the host vehicle supporting folding step 10 may be moved or operated while step 20 is securely maintained in its raised or covering position without annoying rattles or noises. It will also be noted that the entire retaining force which maintains step plate 20 in its raised position is provided by the interaction of rod and spring guide 40 and hinge pin 35 upon hinge plate 30. Thus, no additional latches or locks of any type are required to maintain the raised position of step plate 20.

FIG. 4 sets forth a section view of folding step 10 taken along section lines 4-4 in FIG. 2. Of importance to note is that FIG. 4 is a section view taken through folding step 10 in the lowered or open configuration in which a convenient step is provided.

More specifically, folding step 10 includes an elongated generally rectangular support 11 having an end 12 received within a hitch receptacle (not shown). Support 11 further defines an aperture 25 extending through the sidewall thereof. It will be understood that a corresponding aperture is aligned with an aperture 25 on the opposite side of support 11 which is not visible due to the section view of the figure. Support 11 further defines an interior end 13 and a bottom opening 38. A hinge plate 30 is positioned within the interior of support 11 and is pivotally secured to support 11 by a hinge pin 35. Hinge plate 30 is secured to a generally planar step plate 20 by a plurality of fasteners such as fasteners 31 and 33. Step plate 20 defines an outer surface 21 and a step surface 22. Step surface 22 is partially covered with a friction tab 23.

Folding step 10 further includes an extendable and collapsible rod and spring guide 40 having a rod 42 and an end 41. Rod 42 is secured to an end 44. End 44 is captivated within a concave seat 45. End 41 is pivotally secured to an interior portion of hinge plate 30 by a pivot pin 36. End 41 is generally curved about pin 36 and clears surface 37 formed in hinge plate 30.

As mentioned above, rod and spring guide 40 and spring 43 cooperate with rod 42 to provide an expansive force in the direction indicated by arrow 50. This expansive force acting upon pin 36 and hinge plate 30 produces a pivotal force upon hinge plate 30 and step plate 20 about hinge pin 35 in the direction indicated by arrow 53. The pivotal movement of step plate 20 about hinge pin 35 continues until the bottom portion of surface 39 of hinge plate 30 is brought into contact with the edge of opening 38. At this point, further pivotal movement is precluded and the position of step plate 20 in its horizontal or open position is maintained securely. The continued force provided by spring 43 in the direction indicated by arrow 50 resists upward pivotal movement of step plate 20 and maintains the stable positioning thereof.

Comparison of FIGS. 3 and 4 provides a clear illustration of the two stable positions provided by the over-center combination of hinge pin 35 and rod and spring guide 40 acting upon hinge plate 30. It will be apparent to those skilled in the art that movement between the positions shown in FIG. 3 requires simply overcoming the force of spring 43 within rod and spring guide 40. Thus, moving step plate 20 from the closed position shown in FIG. 3 to the open position shown in FIG. 4 requires force upon step plate 20 in the direction indicated by arrow 53 which is sufficient to overcome the force of spring 43 and partially collapse rod and spring guide 40 as step plate 20 pivots about hinge pin 35. As the user continues to force step plate 20 to pivot about hinge pin 35 in the direction indicated by arrow 53, the maximum compression of rod and spring guide 40 occurs. Following this point of maximum compression of rod and spring guide 40, the force of spring 43 has moved over-center and thereafter aids the pivotal movement of step plate 20 in the direction indicated by arrow 53. Conversely, the user is able to move step plate 20 from the open configuration in FIG. 4 by simply forcing step plate 20 upwardly to induce pivotal movement thereof about hinge pin 35 in the direction indicated by arrow 54. This upward force must be sufficient to overcome the force of spring 43 and begin compressing rod and spring guide 40. Once again as pivotal movement of step plate 20 continues, the point is reached in which rod and spring guide 40 is maximally compressed (conforming generally to center line alignment of hinge pin 35, pin 36 and seat 45) after which continued movement of step plate 20 again pivots step plate 20 over-center and the force of spring 43 begins extending rod and spring guide 40. The force of spring 43 and extension of rod and spring guide 40 following the over-center position movement of step plate 20 allows the force of spring 43 to aid the upward pivotal movement of step plate 20. This upward movement of step plate 20 continues until the position shown in FIG. 3 is obtained and surface 22 of step plate 20 again contacts end 13 of support 11.

Thus, it will be apparent to those skilled in the art from comparison of FIGS. 3 and 4 that the present invention folding step and decorative hitch cover is readily moved between covering and step providing configurations by simple force applied to step plate 20. It will be equally apparent to those skilled in the art that the over-center relationship between hinge pin 35 and rod and spring guide 40 operative upon hinge plate 30 provides secure spring force maintenance of each extreme position and an over-center operation during movement therebetween.

FIG. 5 sets forth a partial side elevation view of an alternate embodiment of the present invention folding step and decorative hitch cover generally referenced by numeral 60. Folding step 60 includes a generally planar step plate 62 secured to a support 61 by a hinge plate 64 and a hinge pin 63. Support 61 is configured to be received within and secured to a hitch receptacle of the host vehicle (not shown). Hinge plate 64 includes a pair of orthogonal cam surfaces 65 and 67 separated by a rounded corner 66. Folding step 60 further includes a coil spring 72 having an end 71 secured to support 61 and a downwardly extending spring end 70. Spring end 70 is positioned against surface 65 of hinge plate 64.

In operation, with step plate 62 in the raised position shown in FIG. 5, surface 65 of hinge plate 64 is positioned against end 70 of coil spring 72. Coil spring 72 produces a spring force against end 70 in the direction indicated by arrow 75. Thus, spring end 70 is forced against surface 65 of hinge plate 64. As a result, step plate 62 is maintained in the raised configuration shown in solid line representation in FIG. 5.

In the event the user desires to lower step plate 62 to the step providing configuration shown in phantom line depiction in FIG. 5, the user applies a force against step plate 62 causing it to pivot about hinge pin 63 in the direction indicated by arrow 78. As the user applies the force to step plate 62, hinge plate 64 is correspondingly pivoted about hinge pin 63 bringing corner surface 66 against spring end 70 as hinge plate 64 pivots in the direction indicated by arrow 77. The continued pivotal movement of step plate 62 and hinge plate 64 in the direction indicated by arrow 77 overcomes the force of spring 72 exerted by spring end 70 and causes spring end 70 to be pivoted in the direction indicated by arrow 76. As the pivotal movement of step plate 62 and hinge plate 64 continues, comer 66 moves upon spring end 70. Once pivotal movement of step plate 62 causes corner 66 to move beyond contact with spring end 70, the force of spring end 70 against surface 67 of hinge plate 64 aids the pivotal movement of step plate 62. The pivotal movement of step plate 62 continues until step plate 62 contacts the undersurface of support 61 preventing further pivotal movement. In the resulting open or step providing configuration, surface 67 of hinge plate 64 is positioned against spring end 70 of spring 72.

Thus, it will be apparent that an over-center bi-stable operation of step plate 62 within folding step 60 similar to that set forth above for folding step 10 is achieved by the cooperation of hinge pin 63, hinge plate 64 and spring 72. Accordingly, step plate 62 is stable in both its raised configuration and its raised configuration and its lowered configuration. Further, it will be apparent that in additional similarity to the embodiment set forth above for folding step 10, folding step 60 may be readily moved between its raised and lowered configurations without resort to any locking or latching apparatus.

FIG. 6 sets forth a top view of a still further alternate embodiment of the present invention folding step and decorative hitch cover generally referenced by numeral 80. Folding step 80 includes a generally planar step plate 81 having a pair of rearwardly extending support flanges 84 and 85. A generally square cross sectioned support member 82 is pivotally secured to flanges 84 and 85 by a hinge pin 86. Support 82 is generally hollow and defines a front end 87 and a rear end 83. Within the interior of support 82, a spring 90 is supported. Spring 90 includes a pair of external downwardly oriented spring ends 91 and 92. In the configuration shown in FIG. 6, spring ends 91 and 92 are pressed against surface 93 of flange 84 and surface 96 of flange 85 respectively. The spring force provided by spring 90 exerted against flanges 84 and 85 maintains the raised configuration of step plate 81.

FIG. 7 sets forth a partial side elevation view of step hitch 80 showing step plate 81 in the raised configuration previously shown in FIG. 6. As described above, step hitch 80 includes a generally planar step plate 81 having rearwardly extending flanges 84 and 85 (seen in FIG. 6). As is also described above, step plate 81 is pivotally secured to a generally square cross sectioned support 82 by a pivot pin 86. Support 82 defines a forward end 87. Flanges 84 and 85 (seen in FIG. 6) are substantially identical in structure and thus the description of flange 84 in FIG. 7 will be understood to apply equally well to flange 85 (seen in FIG. 6).

More specifically, flange 84 is secured to the rear surface of step plate 81 and is pivotally secured to support 82 by pin 86. Flange 84 defines a surface 93 against which end 91 of spring 90 is positioned. Flange 84 further defines a surface 95 and a rounded corner surface 94 therebetween.

The captivation of spring 90 within the interior of support 82 and the shape of spring 90 results in the exertion of a spring force upon end 91 in the direction indicated by arrow 100. This spring force is exerted against surface 93 of flange 84. While not seen in FIG. 7, it will be understood that spring end 92 (seen in FIG. 6) exerts a similar spring force against surface 96 of flange 85 (also seen in FIG. 6).

The force of spring end 91 against surface 93 and the corresponding spring force of spring end 92 against surface 96 (seen in FIG. 6) maintains the raised position of step plate 81. When the user desires to move step plate 81 of step hitch 80 to the lowered or step providing configuration shown in phantom line depiction in FIG. 7, the user simply exerts a downward pivoting force against step plate 81 in the direction indicated by arrow 101. This downward force produces a corresponding rotational movement of flange 94 about pin 86 in the direction indicated by arrow 102. When the downward force upon step plate 81 is sufficient to overcome the force of spring 90, step plate 81 pivots to the lowered position shown in phantom line depiction. The pivoting movement of step plate 81 terminates when the underside of step plate 81 abuts the undersurface of support 82. In this position, flange 84 assumes the configuration shown in phantom line depiction in which spring end 91 is pressed against surface 95 of flange 84. Once again, the force of spring end 91 against surface 95 maintains the lowered position of step plate 81. It should be recalled that a similar operation takes place between spring end 92 and flange 85 (seen in FIG. 6).

Thus, step plate 81 is maintained in a stable position in either the raised position shown in FIG. 7 in solid line depiction or the lowered position shown in FIG. 7 in phantom line depiction. During the transition between raised and lowered positions, the force of spring ends 91 and 92 against the rounded corners such as corner 94 of flange 84 provide the over-center characteristic of step hitch 80 in which the position of step plate 81 is unstable between raised and lowered positions but is stable in both the raised and lowered configurations.

The user is able to raise step plate 81 from its lowered position by simply forcing upwardly on step plate 81 overcoming the force of spring 90 and pivoting step plate 81 once again to the raised position shown in solid line depiction in FIG. 7. Once again, the movement of step plate 81 from the lowered position to its raised position is a over-center movement which terminates when step plate 81 abuts end 87 of support 82.

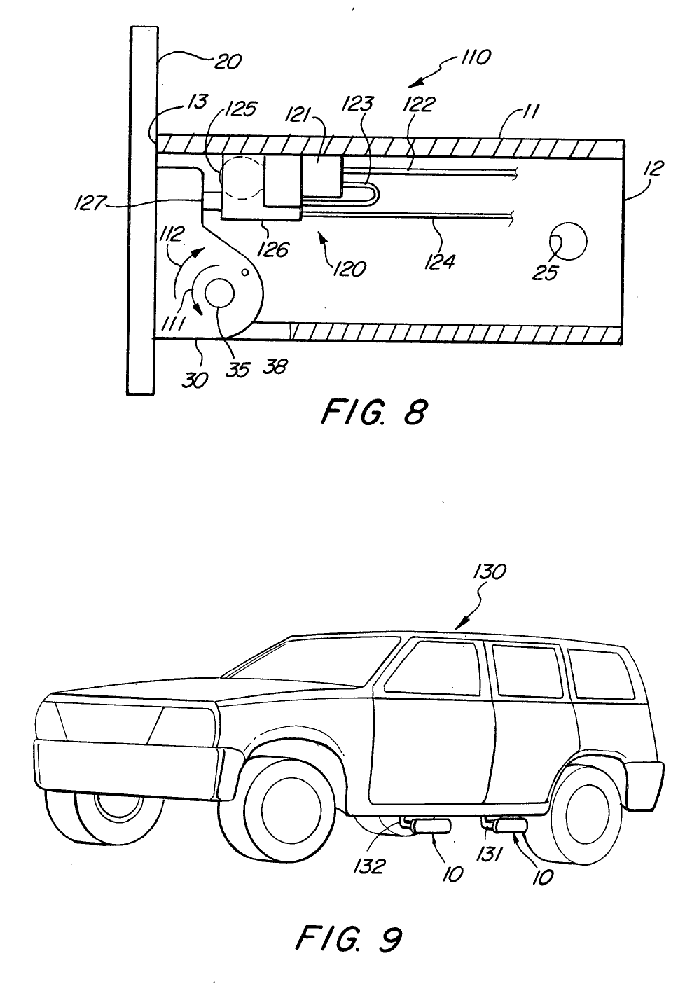

FIG. 8 sets forth a section view of a still further alternate embodiment of the present invention folding step and decorative hitch cover also referred to herein as a step hitch generally referenced by numeral 110. Step hitch 110 will be understood to substantially identical to step hitch 10 set forth above in FIGS. 1 through 4 with the addition of a light assembly generally referenced by a numeral 120. Thus, step hitch 110 includes a support 11 having an aperture 25, an end 12 and an end 13 formed therein. In further accordance with the above described structure of step hitch 10, step hinge 110 includes a step plate 20 having a supporting hinge plate 30 secured to support 11 by a hinge pin 35. As is also described above, step plate 20 and hinge plate 30 are pivotable between raised and lowered positions about pin 35 in the directions indicated by arrows 111 and 112.

In accordance with the alternate embodiment of the present invention set forth in FIG. 8, step hinge 110 further includes light assembly 120 secured within the interior of support 11. Light assembly 120 includes a light socket 121 supporting a light bulb 125. Light assembly 120 further includes a switch 126 coupled to socket 121 and a source of battery power (not shown) by a plurality of conventional connecting wires 122, 123 and 124. Switch 126 includes a push button actuator 127. In the preferred fabrication of switch 126, depressing button 127 against the body of switch 126 opens the connection of switch 126 interrupting the application of power to socket 121 and bulb 125. Thus, in the raised position of step plate 20 shown in FIG. 8, the upper portion of hinge plate 30 presses against push button 127 maintaining switch 126 in its open circuit configuration. Accordingly, no power is applied to bulb 125. In further accordance with the present invention however, when the user pivots step plate 20 downwardly about hinge pin 35, to the lowered position shown in FIG. 4, the force against push button 127 exerted by hinge plate 30 is removed allowing switch 126 to transition to its closed circuit configuration. In this manner, power is applied to socket 121 and bulb 125 producing illumination of step plate 20 when step plate 20 is moved to the lowered position such as shown in FIG. 4. In this manner, step plate 20 is illuminated for additional safety when utilized in darkened areas or at night.

When step plate 20 is moved from its lowered position to the raised position shown in FIG. 8, the pivoting of hinge plate 30 about pin 35 brings the upper portion of hinge plate 30 against push button 27 returning switch 126 to its open circuit condition and terminating the electrical power applied to bulb 125. Accordingly, bulb 125 is not illuminating when step plate 20 is in the raised position shown.

FIG. 9 sets forth a perspective view of a typical host vehicle 130 having a pair of folding step and decorative hitch covers generally referenced by numeral 10 which are utilized in a further variation. In the configuration shown in FIG. 9, a pair of rectangular cross section support 131 and 132 are joined to the support apparatus of vehicle 130 (not shown) in accordance with conventional fabrication techniques such as frame welding or the like. Of importance with respect to the present invention, is the provision of supports 131 and 132 which are suitably shaped and configured to receive supports 11 (seen in FIG. 4) of the present invention folding step and decorative hitch covers. As a result, step hitches 10 shown secured to supports 131 and 132 while not involved with a trailer hitch may be utilized nonetheless as a convenient folding step for vehicle 130.

What has been shown is a folding step and decorative hitch cover which is extremely safe and reliable in use and which may be readily secured to or removed from a conventional trailer hitch of a host vehicle. In an additional embodiment, a lighted source within the hitch cover is activated each time the step plate of the hitch cover is moved to its lowered or step providing position.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in combination with a vehicle trailer hitch in which the trailer hitch includes a hitch receptacle, a folding step and decorative hitch cover comprising:
a support having a first end configured to be secured to a hitch receptacle and a second end;
a step plate pivotally secured to said second end, movable between a closed position and a lowered position; and
an over-center spring mechanism operative upon, said step plate to bias said step plate toward said closed position and said open position away from positions therebetween.

2. The folding step and decorative hitch cover set forth in claim 1 wherein said over-center spring mechanism includes pivot limit stops at each of said closed and open positions.

3. The folding step and decorative hitch cover set forth in claim 2 wherein said step plate includes a generally planar step surface.

4. The folding step and hitch cover set forth in claim 3 wherein said step surface further includes a friction pad formed of a resilient material.

5. The folding step and hitch cover set forth in claim 4 further including:
a light source;
switch means for activating and deactivating said light source; and
actuation means operative upon said switch means for activating said light source solely in said open position of said step plate.

6. The folding step and hitch plate set forth in claim 1 wherein said over-center spring mechanism includes:
a hinge plate secured to said step plate;
a extendible rod and spring guide having a first end secured to said hinge plate and a second end secured to said support; and
a coil spring upon said extendible rod and spring guide urging said first and second ends apart.

7. The folding step and decorative hitch cover set forth in claim 6 wherein said over-center spring mechanism includes pivot limit stops at each of said closed and open positions.

8. The folding step and decorative hitch cover set forth in claim 7 wherein said step plate includes a generally planar step surface.

9. The folding step and hitch cover set forth in claim 8 wherein said step surface further includes a friction pad formed of a resilient material.

10. The folding step and hitch cover set forth in claim 9 further including:
a light source;
switch means for activating and deactivating said light source; and
actuation means operative upon said switch means for activating said light source solely in said open position of said step plate.

11. The folding step and hitch cover set forth in claim 1 wherein said over-center spring mechanism includes:
a pair of flanges secured to said step plate each having first and second surfaces and a rounded surface therebetween; and
a spring supported by said support having a pair of spring ends each forced against one of said flanges.

12. The folding step and hitch cover set forth in claim 11 wherein each of said first and second surfaces are generally orthogonal.

13. The folding step and decorative hitch cover set forth in claim 11 wherein said over-center spring mechanism includes pivot limit stops at each of said closed and open positions.

14. The folding step and decorative hitch cover set forth in claim 13 wherein said step plate includes a generally planar step surface.

15. The folding step and hitch cover set forth in claim 14 wherein said step surface further includes a friction pad formed of a resilient material.
